(19) United States
(12) Patent Application Publication
(10) Pub. No.: US 2024/0306628 A1
(43) Pub. Date: Sep. 19, 2024

(54) System for Spraying a Composition of Live Biological Control Agents

(71) Applicant: Bioline Agrosciences France, Paris (FR)

(72) Inventors: Jacques Frandon, Antibes (FR); Pascal Maignet, Saint Vallier De Thiey (FR)

(21) Appl. No.: 18/267,858

(22) PCT Filed: Dec. 20, 2021
(86) PCT No.: PCT/FR2021/052405

§ 371 Date: Jun. 16, 2023

(30) Foreign Application Priority Data
Dec. 18, 2020 (FR) 2013693

(51) Int. Cl. A01M 7/00

(52) U.S. Cl. CPC A01M 7/0092

(57) ABSTRACT

The present invention relates to a system for dispersing live biological control agents, comprising a reservoir of live biological control agents in liquid phase, a source of compressed air, a nozzle comprising a tip, the biological control agent line having a liquid phase outlet for a liquid phase jet to exit the tip in a main direction, and the compressed air line having at least one air outlet, the tip comprising a wall, the liquid phase outlet being defined by an opening in the wall of the tip, the one or more air outlets being arranged in the wall of the tip, the shape of the wall being configured to direct a flow of main air exiting the one or more air outlets in a converging manner towards the liquid phase jet.

### FIELD OF THE INVENTION

The invention relates to a system for dispersing live biological control agents, for example from the phytoseiid family of genus Phytoseiulus.

### STATE OF THE ART

When dispersing predatory mites of genus Phytoseiulus, bottles containing an inert solid carrier, such as vermiculite, in which the mites move, are conventionally used. The mites naturally move to the top of the packaging and this results in a very heterogeneous distribution of the mites when they come out of the bottles.

It is also known to deposit the support directly on plants subject to biological control. However, the support can fall from the plants, resulting in a loss of predatory mites on the plants, and thus a reduction in the effectiveness of this biological control method.

There is therefore a need for another method for dispersing live and mobile mites in an aqueous medium on plants or culture media within the framework of a biocontrol strategy.

However, mites of genus Phytoseiulus are known to be fragile, strictly aerial and unsuited to an aqueous medium, for example when they are at ground level, because they only interact with the aerial part of plants where their prey is found.

### DISCLOSURE OF THE INVENTION

An object of the invention is to provide a system for dispersing live biological control agents homogeneously in cultures.

This object is achieved in the context of the present invention thanks to a system for dispersing live biological control agents, comprising:
a reservoir of live biological control agents in liquid phase,
a source of compressed air,
a nozzle, the nozzle being connected to the reservoir of biological control agents by a biological control agent line, and to the source of compressed air by a compressed air line, the nozzle comprising a spray tip,
the biological control agent line having a liquid phase outlet for a liquid phase jet to exit the tip in a main direction, and the compressed air line having at least one air outlet,
the tip comprising a wall, the liquid phase outlet being defined by an opening in the wall of the tip,
the one or more air outlets being arranged in the wall of the tip, the shape of the wall being configured to direct a flow of main air exiting the one or more air outlets in a converging manner towards the liquid phase jet, the flow of main air preferably having an axial symmetry with respect to the main direction.

The invention is advantageously completed by the following characteristics, taken individually or in any of their technically possible combinations:
the nozzle comprises at least two air outlets arranged symmetrically with respect to the main direction, the shape of the wall being configured to direct a first air flow exiting one of the air outlets towards the liquid phase jet, and to direct a second air flow exiting the other air outlet towards the liquid phase jet, the first air flow and the second air flow being symmetrical with respect to the main direction,
the system comprises a reservoir of enzymes in liquid phase, the enzyme reservoir being fluidically connected to the biological control agent line, preferably by a mixer adapted to mix live biological control agents in liquid phase and an enzyme solution,
the system comprises means for compressing the reservoir of biological control agents and/or the enzyme reservoir, adapted to entrain a flow from the reservoir of biological control agents and/or from the enzyme reservoir to the liquid phase outlet,
the opening has a diameter greater than 1 mm, and preferably greater than 1.5 mm,
the compression means are implemented by a compression line connecting the compressed air line and the reservoir of biological control agents, and/or connecting the compressed air line and the enzyme reservoir,
the reservoir of biological control agents comprises an aqueous composition, and biological control agents are dispersed in the aqueous composition,
the aqueous composition comprises a gel prepared from one or more thickeners and/or gelling agents and an aqueous solution, the live biological control agents being homogeneously dispersed in the gel, said thickeners and/or gelling agents being non-toxic for said biological control agents and said gel having a dynamic viscosity at zero speed gradient comprised between 1 and 30 000 mPa·s,
live biological control agents are mobile,
the live biological control agents are selected from the group consisting of mites and/or insects that prey on mites,
live biological control agents are mites from the phytoseiid family of genus Phytoseiulus,
the live biological control agents are insects of the Chrysoperla type which prey on insect pests, in particular aphids,

Another object of the invention is a method for dispersing live biological control agents, which are preferably mobile, the method comprising a step of spraying an aqueous composition of live biological control agents by a system according to one embodiment of the invention, in which a flow of main air is entrained from the source of compressed air to the spray tip, a flow of an aqueous composition comprising the live biological control agents in liquid phase is entrained to the opening, an average speed of the air flow in the air line being adapted to spray the aqueous composition by shearing the aqueous composition by the air flow.

Advantageously, the diameter of the opening and the average speed of the flow of aqueous composition are adapted so that the liquid phase jet is not sprayed at the outlet of the opening.

Advantageously, the aqueous composition comprising the biological control agents is sprayed only by the flow of main air after exiting the opening.

Advantageously, in a method according to one embodiment of the invention, the system comprises means for compressing the reservoir of biological control agents adapted to entrain a flow from the reservoir of biological control agents and/or from the enzyme reservoir to the liquid phase outlet, and the compression means are controlled so as to impose a pressure that is strictly less than 3 bar in the reservoir of biological control agents, and preferably less than 0.5 bar.

### DESCRIPTION OF THE FIGURES

Other characteristics, objects and advantages of the invention will emerge from the description which follows, which is purely illustrative and not limiting, and which must be read in conjunction with the appended drawings in which:

FIG. 1 schematically illustrates a system for dispersing live biological control agents according to one embodiment of the invention.

FIG. 2 illustrates the survival rate of live biological control agents after being dispersed by a system according to one embodiment of the invention and by other systems.

FIG. 3 illustrates the survival rate of live biological control agents after being dispersed by a system according to four embodiments of the invention.

In all the figures, similar elements bear identical references.

### Definition

In all the described embodiments of the invention, “bar” means a unit of pressure exactly equal to 100 000 pascals, the zero of which corresponds to atmospheric pressure. The “bar” thus defined is also called “bar gauge” (denoted barg), whose definition is strictly identical. “Bar” does not mean a unit of absolute pressure, denoted “para”, whose zero is representative of absolute vacuum.

### DETAILED DESCRIPTION OF THE INVENTION

### General Architecture of the System

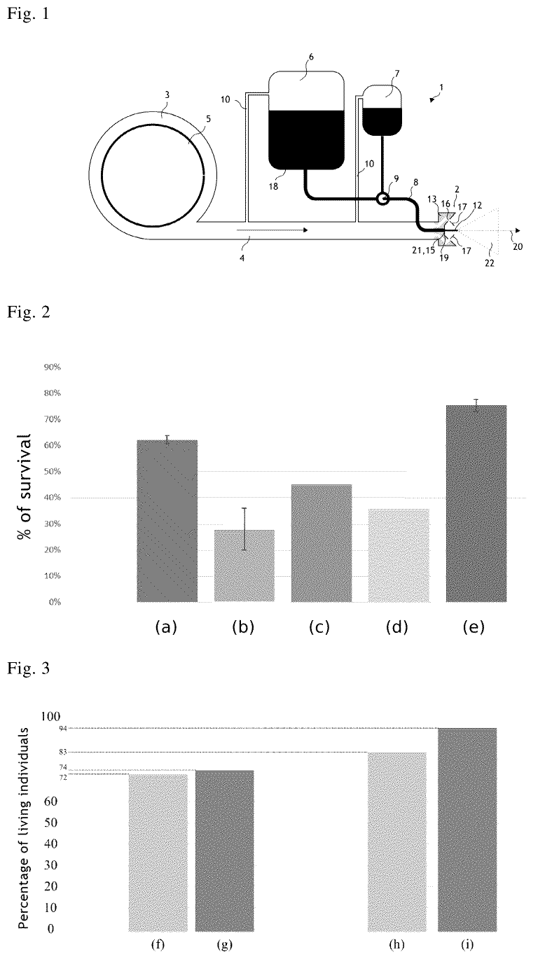

With reference to FIG. 1, a system 1 for dispersing live biological control agents comprises a reservoir of live biological control agents 6 in liquid phase. The reservoir of biological control agents 6 may have a volume greater than two liters, preferably greater than five liters, in particular greater than 10 liters. The reservoir of biological control agents 6 can preferably comprise an aqueous composition 18, the aqueous composition 18 comprising dispersed live biological control agents.

The system 1 also comprises a source of compressed air 3. The source of compressed air 3 can preferably be implemented by a ventilation turbine 5, which allows the system 1 to be portable while allowing the source of compressed air 3 to produce air having a pressure greater than 1 bar, preferably greater than 2 bar.

The system 1 comprises a nozzle 2. The nozzle 2 is connected to the reservoir of biological control agents 6 by a line 8 of biological control agents in liquid phase. The biological control agent line 8 is preferably a flexible tube. The biological control agent line 8 has a liquid phase outlet 15.

The nozzle 2 is also connected to the source of compressed air 3 by a compressed air line 4. The compressed air line 4 is preferably a flexible tube. The compressed air line 4 has an air outlet 16.

The nozzle 2 comprises a spray tip 13. The biological control agent line 8 has a liquid phase outlet 15 for a liquid phase jet 12 to exit the tip 13 in a main direction 20. “Liquid phase jet” means a continuous flow of liquid phase surrounded by a gas phase, which is not sprayed into droplets. Directly after the exit of the liquid phase 15 from the opening 21, when using the system, the liquid phase jet 12 is not yet sprayed. The compressed air line 4 has at least one air outlet 16. The source of compressed air 3 can be configured so that the air, at the tip 13, and preferably at the one or more air outlets 16, has a speed comprised between 5 m/s and 30 m/s, in particular between 10 m/s and 25 m/s. The tip 13 comprises a wall 19. The liquid phase outlet 15 is defined by an opening 21 in the wall 19 of the tip 13. The one or more air outlets 16 are also arranged in the wall 19 of the tip 13. The shape of the wall 19 is configured to direct a flow of main air 17 exiting the one or more air outlets 16 in a convergent manner towards the liquid phase jet 12, the flow of main air 17 preferably having axial symmetry with respect to the main direction.

Thus, an aqueous composition comprising live biological control agents can be mainly sprayed, preferably only sprayed, by the flow of air meeting the liquid phase jet comprising the aqueous composition, at the liquid phase outlet 15, shear being exerted at the interface of the aqueous composition. This shear results in the splitting of the jet and therefore of the aqueous composition into very small droplets. A spray jet 22 is thus produced at the outlet of the nozzle 2.

As this shear is implemented by air at the interface of the composition, the composition can be sprayed significantly increasing the survival rate of live biological control agents of the aqueous composition. The inventors have discovered that the passage of live biological control agents through a nozzle resulting in the spraying by mechanical stress of a solid part is detrimental to their survival after dispersion, because of the risk of injury to the agents, in particular when the pressure imposed on the aqueous composition is greater than 0.5 bar. The nozzle 2 according to one embodiment of the invention allows to avoid this cause of mortality of live biological control agents.

With reference to FIG. 1, the nozzle 2 comprises at least two air outlets 16 arranged symmetrically with respect to the main direction 20, the shape of the wall 19 being configured to direct a first air flow exiting one of the air outlets 16 towards the liquid phase jet 12, and to direct a second air flow exiting the other air outlet 16 towards the liquid phase jet 12, the first air flow and the second air flow, forming the flow of main air 17, being symmetrical with respect to the main direction 20. Thus, it is possible to spray the liquid phase jet 12 comprising the aqueous composition mainly by air/liquid contact, and preferably only by air/liquid contact, in a direction determined by the position of the nozzle 2 in space.

Alternatively, the air outlet 16 may be defined by a crown completely surrounding the opening 21. Alternatively, the wall may have four air outlets or a greater and even number of air outlets 16, for example eight air outlets 16, arranged symmetrically around the opening 21.

Preferably, the shape of the wall can be configured so that the direction of the flow of main air 17 forms an angle with the main direction 20 comprised between 30 and 60 degrees, and preferably comprised between 40 and 50 degrees. Thus, the spraying of the aqueous composition can take place both by the shearing of the air flow in contact with the flow of aqueous composition and by the entry of the air flow into the flow of aqueous composition, and by the convergence of the air jets towards the flow of aqueous composition.

The diameter of the opening 21 is configured so that, for a predetermined flowrate of the flow of aqueous composition, or for a predetermined average speed of the flow of aqueous composition 18 in the biological control agent line 8, the exit of the liquid phase jet, comprising the aqueous composition 18, outside the tip 13 does not result in spraying the aqueous composition. Thus, the live biological control agents can exit the nozzle 2 without undergoing a mechanical stress strong enough to injure them when passing through the opening 21. Indeed, the spray is physically driven both by a sufficiently small diameter of the opening and by a sufficiently high flow speed. Thus, the person skilled in the art, for a predetermined flow speed, will know how to adapt the diameter of the opening in such a way, that is to say high enough, so that the liquid phase jet is not mainly sprayed through the opening 21. In addition, the diameter of the opening 21 is chosen according to the size of the live biological control agents. Preferably, the diameter of the opening 21 is chosen to be greater than twice, in particular greater than three times, the size of the live biological control agent. Thus, the live biological control agent undergoes limited shearing, which allows to increase the survival of the live biological control agents at the outlet of the system 1 during the dispersion of the live biological control agents. For the preferential flow speeds of the embodiments of the invention, the opening 21 has a diameter greater than 1 mm, and preferably 1.5 mm. Thus, the aqueous composition is not mainly sprayed while passing through the opening 21, but mainly during shearing with the air flow 17. The reservoir of biological control agents 6 can be compressed, preferably by the source 3 of compressed air via a compression line 10, so as to entrain a flow of aqueous composition 18 at the opening 21 comprised between 2 mL/s and 4.5 mL/s.

### Composition of Biological Control Agents

The sprayable aqueous composition comprises live biological control agents homogeneously dispersed in a gel prepared from one or more thickeners and/or gelling agents and an aqueous solution. The thickeners and/or gelling agents are non-toxic for said biological control agents and said gel has a dynamic viscosity at zero speed gradient comprised between 1 and 30 000 mPa·s.

Preferably, said gel has a dynamic viscosity at zero speed gradient comprised between 10 and 25 000 mPa·s, more preferably between 2 and 5 000 mPa·s, more preferably between 60 and 4 500 mPa·s, more preferably between 80 and 150 mPa·s.

Preferably, the live biological control agents are selected from mobile live biological control agents. “Mobile” means that the live biological control agent exists in a form which allows it, at the time of use of the system, to be mobile in space, and particularly in a culture. Indeed, the inventors have discovered that mobile live biological control agents are particularly affected by shear spraying by a solid material. Thus, a spray driven mainly by shear between the air and the aqueous composition allows to spray mobile live biological control agents with a high survival rate.

Preferably, the live biological control agents can be selected from the group consisting of mites and/or insects that prey on crop pests, preferably mites.

Preferably, the live biological control agents are insects of the Chrysoperla type which prey on crop pests, in particular aphids. Live biological control agents can be in the form of eggs.

According to one embodiment, said live biological control agents are mites of the Phytoseiidae family or predatory soil mites, preferably Hypoaspis miles; Macrocheles robustulus; Gaeolaelaps aculeifer.

Preferably, said biological control agents from the Phytoseiidae family are selected from the group consisting of the genera Phytoseiulus, preferably Phytoseiulus persimilis, Phytoseiulus macropilis, Phytoseiulus longipes or Phytoseiulus fragariae, and genus Amblyseius, preferably Amblyseius swirskii, Amblyseius californicus, Amblyseius cucumeris, Amblyseius andersoni and Amblyseius montdorensis.

According to one embodiment, said live biological control agents are Diptera insects, preferably from the family of Cecidomyiidae or hymenoptera, preferably from the families of Brachonidae, Aphelinidae or Trichogrammatidae.

Preferably, said biological control agents from the family of Cecidomyiidae are selected from the group consisting of Feltiella acarisuga and Aphidoletes aphidimyza.

Preferably, said biological control agents from the family of Brachonidae are selected from the group consisting of Aphidius colemani; Aphidius ervi, Aphidius matricariae.

Preferably, said biological control agents from the family of Aphelinidae are selected from the group consisting of Aphelinus abdominalis, Encarsia formosa; Eretmocerus eremicus; Eretmocerus mundus.

According to one embodiment, said live biological control agents are nematodes of the family of Steinernematidae or the family of Heterorhabditidae or the family of Rhabditidae.

Preferably, said biological control agents from the family of Steinernematidae are selected from the group consisting of Steinernema carpocapsae; Steinernema kraussei, Steinernema feltiae.

Preferably, said biological control agents from the family of Heterorhabditidae are selected from the group consisting of Heterorhabditis bacteriophora.

Preferably, said biological control agents from the family of Rhabditidae are selected from the group consisting of Phasmarhabditis bacteriophora.

Preferably, said biological control agents are present in the aqueous composition in the form of larvae, nymphs, pupae and/or adults.

Preferably, said biological control agents are present in the composition in the form of any stage of development with the exception of eggs.

Preferably, the system 1 allows to maintain at least 60%, preferably at least 70%, more preferably at least 80%, particularly preferably at least 90% of the biological control agents of the phytoseid family of genus Live Phytoseiulus for at least 2 hours, preferably 6 hours, more preferably 12 hours.

Preferably, the system 1 allows to maintain at least 60%, preferably at least 70%, more preferably at least 80%, particularly preferably at least 90% of the control longevity of the biological control agents of the phytoseid family of genus Phytoseiulus for at least 2 hours, preferably 6 hours, more preferably 12 hours.

“Control longevity” is defined as less than 20% mortality at 5 days.

Preferably, the system 1 allows to maintain at least 60%, preferably at least 70%, more preferably at least 80%, particularly preferably at least 90% of the control fecundity of the biological control agents of the phytoseid family of genus Phytoseiulus for at least 2 hours, preferably 6 hours, more preferably 12 hours.

“Control fecundity” is defined as a fecundity greater than or equal to 10 eggs/female/5 days, in particular for biological control agents from the phytoseid family of genus Phytoseiulus.

The composition allows, after being dispersed or sprayed in drops, a rate of release from the gel of the biological control agents from the phytoseid family of genus live Phytoseiulus greater than 60%, in particular greater than 80%.

### Thickeners/Gelling Agents

The appropriate thickeners/gelling agents and their concentration for preparing the sprayable aqueous composition are selected to satisfy the viscosity criterion described above, to allow homogeneous dispersion in the composition of the biological control agents, in particular from the phytoseid family of genus Phytoseiulus, and to be non-toxic to live biological control agents.

“Non-toxic” means less than 20% biological control agents dead after 2 hours.

Furthermore, the thickeners/gelling agents suitable for preparing the composition are selected so as to be neither toxic for the concerned crop plants, nor for the consumer of said plants or by-products of said plants.

Preferably, the thickeners/gelling agents suitable for preparing the composition are food thickeners/gelling agents.

More preferably, the thickeners/gelling agents suitable for preparing the composition are selected from the group consisting of:
polyoses and osides. Mention may be made in this family by way of examples of: alginate, modified corn starch, amylopectin, carrageenans, chitosan, dextrin, guar gum, xanthan gum, glycerol, konjac gum.
polyacrylate salts. Mention may be made in this family by way of examples of: Carbomer 940 (polyacrylic acid), Gel maker emu (sodium polyacrylate).
povidone derivatives. Mention may be made in this family by way of examples of: PVP (Polyvinylpyrrolidone).
cellulose derivatives. Mention may be made in this family by way of examples of: Carboxymethylcellulose, hydroxypropylcellulose.
metal salts. Mention may be made in this family by way of examples of: Calcium chloride, potassium chloride, aluminum sulphate.

Preferably, said thickeners/gelling agents are used in the composition at a concentration comprised between 0.5 and 200 g/L, preferably between 1 and 90 g/L, more preferably between 2 and 40 g/L.

More preferably, the thickeners/gelling agents suitable for preparing the composition are selected from the group consisting of polyoses and osides.

Particularly preferably, said polyoses and osides are selected from the group consisting of modified corn starch, carrageenans, xanthan gum and konjac gum.

Preferably, the modified corn starch is used at a concentration comprised between 30 and 90 g/L, preferably at 34 g/L.

Preferably, a modified corn starch gel is used at a dynamic viscosity at zero speed gradient comprised between 60 and 100 mPa·s, preferably at 80 mPa·s.

Preferably, the carrageenans are used at a concentration comprised between 1 and 10 g/L, preferably at 3 g/L.

Preferably, a carrageenan gel is used at a dynamic viscosity at zero speed gradient comprised between 1 and 4900 mPa·s, preferably at 2 mPa·s.

Preferably, the xanthan gum is used at a concentration comprised between 0.5 and 5 g/L, preferably at 2 g/L.

Preferably, a xanthan gum gel is used at a dynamic viscosity at zero speed gradient comprised between 7 and 1680 mPa·s, preferably at 135 mPa·s.

Preferably, the konjac gum is used at a concentration comprised between 0.5 and 10 g/L, preferably at 4 g/L.

Preferably, a konjac gum gel is used at a dynamic viscosity at zero speed gradient between 1 and 450 mPa·s, preferably at 27 mPa·s.

### Enzymes

The aqueous composition may further comprise an enzyme capable of degrading the gel prepared from one or more thickeners and/or gelling agents and an aqueous solution at a concentration of the enzyme in the aqueous solution allowing total degradation of said gel in less than 10 minutes, preferably in less than 5 minutes, more preferably in less than 2 minutes.

The addition of the enzyme to the composition allows to improve the rate of release, from the gel, of the live biological control agents, in particular of the family of live phytoseids of genus Phytoseiulus after dispersion or spraying of the composition.

Preferably, the release rate of a composition according to the invention with enzyme is greater than 80%.

Preferably, the enzyme is added last to the composition according to the invention, in particular after the gelling agent or the thickener and after the live biological control agents.

Preferably, the enzyme is added to the aqueous composition less than 2 hours before its dispersion/spray, preferably just before its dispersion/spray.

The system 1 preferably comprises an enzyme reservoir 7 in liquid phase. The enzyme reservoir 7 is fluidically connected to the biological control agent line 8. Thus, during the dispersion of the live biological control agents, it is possible to add the enzyme immediately before the spraying of the aqueous composition, and thus avoid degrading the rheological properties of the aqueous solution before spraying. Preferably, the enzyme reservoir 7 is connected to the biological control agent line 8 by a fluid mixer, adapted to mix live biological control agents in liquid phase and an enzyme solution. The mixer can be selected from a water pump which allows suction of a liquid by the passage of another liquid by mixing the two liquids, and a fluid junction system. Alternatively, the mixer can be arranged between the nozzle 2 and the fluidic connection connecting the biological control agent line 8 and a line connecting to the enzyme reservoir 7.

The enzyme is of course suitable for degrading said thickener/gelling agent of the composition.

The most favorable conditions are obtained when the enzyme rapidly degrades the gel since the faster the gel is degraded, the more rapidly the biological control agents are released.

The person skilled in the art will know how to choose the concentration of the enzyme according to its enzymatic activity, the optimum temperature, the concentrations of the thickener and the desired hydrolysis duration.

Preferably, the concentration of the enzyme is chosen to degrade 100% of the gel in less than 12 hours, preferably in less than 6 hours, more preferably in less than 2 hours, particularly preferably in less than 1 min.

For example, use will be made of enzymes:
Hydrolyzing oside bonds for the oside/polyose family.

In the case of alginate, alginate lyase degrades alginate by β-elimination of oside bonds.

In the case of modified corn starch, alpha-amylase hydrolyzes the alpha (1,4) oside bonds. For example, use is made of an alpha-amylase with an enzymatic activity of 800 FAU/g at 20° C., 1 FAU hydrolyzing 17 mg of starch per minute. To degrade 100 mL of modified corn starch at 34 g/L in 1 minute, 200 FAU or 0.25 g of alpha-amylase are needed. For degradation in two hours, 1.6 FAU or 0.002 g of alpha-amylase are needed. Finally, for degradation in 12 hours, 0.27 FAU or 0.3 mg of alpha-amylase are needed.

In the case of amylopectin, alpha-amylase hydrolyzes alpha (1,4) oside bonds.

In the case of dextrins, glycose hydrolase limit dextrinase hydrolyzes alpha (1,6) oside bonds.

In the case of carrageenans, k-carrageenase hydrolyzes alpha (1,4) oside bonds.

In the case of Guar and Xanthan gums, beta-mannanase randomly hydrolyzes (1,4)-β-D-mannosidic bonds. For Xathane Gum, xanthan lyase hydrolyzes beta-D-mannosyl-beta-D-1,4-glucuronosyl bonds.

In the case of chitosan, chitosanase hydrolyzes the beta (1,4) oside bonds between D-glucosamine residues.

In the case of konjac, endo-1,4 beta-mannanase hydrolyzes the beta (1,4) saccharide bonds of glucomannan residues.
For cellulose derivatives:

Endo-cellulase: breaks the crystal structure of cellulose into polysaccharide chains.

Exo-cellulase: cuts 2-4 units at the ends of the polysaccharide chains.

β-glucosidase: hydrolyzes polysaccharide chains into monosaccharides.

Oxidative cellulase: depolymerizes cellulose

Cellulose phosphorylase: depolymerizes cellulose using phosphates.

### Fluid Flows in the System 1

The system 1 can comprise means for compressing the reservoir of biological control agents 6 and/or the enzyme reservoir 7. The compression means are adapted to entrain a flow from the reservoir of biological control agents 6 and/or from the enzyme reservoir 7 to the liquid phase outlet 15. Thus, it is possible to implement flows comprising live biological control agents without risking reducing their survival rate. Indeed, some pumps can cause injuries by mechanical pressure and degrade the survival of live biological control agents.

Preferably, the compression means are implemented by a compression line 10 connecting the compressed air line 4 and the reservoir of biological control agents 6, and/or connecting the compressed air line 4 and the enzyme reservoir 7. The compression line 10 can be dimensioned so as to compress the reservoir of biological control agents 6 and/or the enzyme reservoir 7 at a predetermined pressure, depending on the pressure of the air source 3. Thus, it is possible to simultaneously trigger the flow of air 17, the flow of aqueous composition and preferably a flow of enzymes by controlling only the source 3 of compressed air.

It is also possible to use pumps of the peristaltic type to entrain the solutions from the reservoir of biological control agents 6 and/or from the enzyme reservoir 7 to the liquid phase outlet.

### The Method for Preparing the Composition

The method for preparing the composition according to the invention comprises the following steps:
dissolving the thickener(s) and/or gelling agent(s) in an aqueous base, preferably in water, preferably in water, until a gel is formed,
adding biological control agents, in particular from the phytoseiid family of genus Phytoseiulus, and their homogeneous dispersion in the gel, preferably by light stirring of the solution,
optionally adding an enzyme capable of degrading the gel at a concentration allowing complete degradation of said gel in less than 12 hours, preferably in less than 2 hours.

This preparation method is preferably carried out between 18° C. and 25° C., particularly preferably at 20° C.

This preparation method is preferably carried out at a relative humidity greater than 30%, preferably 60%.

### The Method for Dispersing the Aqueous Composition

One aspect of the invention is a method for dispersing live biological control agents. The method comprises a step of spraying the aqueous composition of live biological control agents by a system according to one embodiment of the invention.

The method comprises a step in which a flow of air 17 is entrained from the source of compressed air 4 to the spray tip 13.

The method also comprises a step in which a flow of an aqueous composition comprising the live biological control agents in liquid phase is entrained to the spray tip 13.

The method is implemented such that an average speed of the air flow 17 in the air line 4 is adapted to spray the aqueous composition by shearing the aqueous composition by the air flow. Preferably, the ratio between the average speed of the air flow in the air line 4 and between the average speed of the flow of aqueous composition is greater than a predetermined ratio, above which the aqueous composition can be sprayed by shear by the air flow 17. Preferably, the average speed of the air flow at the tip 13, and preferably at the one or more air outlets 16, has a speed comprised between 5 m/s and 30 m/s, in particular comprised between 10 m/s and 25 m/s. Preferably, the average speed of the flow of aqueous composition is comprised between 1 m/s and 5 m/s, in particular between 1.5 m/s and 3 m/s. Thus, it is possible to spray the aqueous composition without shearing it by a solid material, which allows to reduce the mechanical stress exerted on the biological control agents at a constant flow rate of aqueous composition, and thus to increase the survival rate of the live biological control agents. Indeed, the spraying of the aqueous composition with air allows to increase the survival rate of the live biological control agents.

Preferably, the aqueous composition is sprayed only through the main air flow 17 after exiting the opening 21. Thus, the survival rate of the live biological control agents can be increased relative to the survival rate of biological control agents sprayed at least in part by contact between the aqueous composition and the opening.

Preferably, the compression means are controlled so as to impose a pressure strictly less than 3 bar and preferably strictly less than 1 bar in the reservoir of biological control agents 6, in particular less than 0.5 bar, and preferably less than 0.3 bar. Indeed, it has been observed that the storage of biological control agents at a too high pressure, in particular greater than 3 bar, and in particular greater than 0.5 bar, increases the mortality of the biological control agents.

### EXAMPLES

With reference to FIG. 2, the survival rate of live biological control agents was measured after spraying the aqueous composition for different systems. The measurement (a), the measurement (b), the measurement (c) and the measurement (d) correspond to spraying of the aqueous composition by nozzles resulting in the spraying of a composition by passage through a small opening before the composition exits the system. The measurement (e) corresponds to the spraying of the aqueous composition through a nozzle according to one embodiment of the invention. It is observed that the survival rate of the live biological control agents is significantly higher during measurement (e), that is to say using a system according to one embodiment of the invention. In particular, the survival rate of live biological control agents dispersed by a system 1 according to one embodiment of the invention is greater than 80%.

With reference to FIG. 3, an experiment was conducted using two nozzles according to one embodiment of the invention.

Measurements (f) and (h) were obtained with a first nozzle having a spray tip opening with a diameter of 1.8 mm comprised between 1 mm and 1.5 mm. This first nozzle comprises two air outlets placed on either side of the opening and each having a diameter of 7 mm. The outlet air speed is about 20 m/s.

The measurements (g) and (i) were obtained with a second nozzle having a spray tip opening greater than 1.5 mm, and more exactly equal to 2.2 mm. This second nozzle comprises two air outlets placed on either side of the opening and each having a diameter of 8 mm. The outlet air speed is about 20 m/s.

Measurements (f) and (g) were obtained using a composition of biological control agents placed in a gel comprising a modified corn starch thickener/gelling agent further comprising enzymes.

Measurements (h) and ig) were obtained using a composition of biological control agents placed in a gel comprising an enzyme-free xanthan gum thickener/gelling agent.

The results of the experiment illustrated in FIG. 3 show in particular that the survival rate of the mites is higher using xanthan gum without enzymes rather than corn starch modified with enzymes.

For both types of gel, the nozzle with a larger diameter spray tip opening achieves a higher survival rate.

1. A system for dispersing live biological control agents, the system comprising:
a reservoir of live biological control agents in liquid phase,
a source of compressed air,
a nozzle, the nozzle being connected to the reservoir of biological control agents by a biological control agent line, and the nozzle being connected to the source of compressed air by a compressed air line, the nozzle comprising a spray tip,
the biological control agent line having a liquid phase outlet configured to let a liquid phase jet exit from the spray tip in a main direction, and the compressed air line having at least one air outlet,
the spray tip comprising a wall, the liquid phase outlet being defined by an opening in the wall of the spray tip,
the at least one air outlets being arranged in the wall of the spray tip, the shape of the wall being configured to direct a flow of main air exiting the at least air outlets in a convergent manner towards the liquid phase jet, the flow of main air having an axial symmetry with respect to the main direction.

2. The system according to claim 1, wherein the nozzle comprises at least two air outlets arranged symmetrically with respect to the main direction, the shape of the wall being configured to direct a first air flow exiting one of the at least two air outlets towards the liquid phase jet, and to direct a second air flow exiting the other air outlet towards the liquid phase jet, the first air flow and the second air flow being symmetrical with respect to the main direction.

3. The system according to claim 1, comprising a reservoir of enzymes in liquid phase, the enzyme reservoir being fluidically connected to the biological control agent line, by a mixer configured to mix live biological control agents in liquid phase and an enzyme solution.

4. The system according to claim 1, comprising compression means for compressing the reservoir of biological control agents and/or the enzyme reservoir, the compression means being configured to entrain a flow from the reservoir of biological control agents and/or from the enzyme reservoir to the liquid phase outlet.

5. The system according to claim 1, wherein the opening has a diameter greater than 1 mm.

6. The system according to claim 4, wherein the compression means comprise a compression line, the compression line connecting the compressed air line and the reservoir of biological control agents, and/or connecting the compressed air line and the enzyme reservoir.

7. The system according to claim 1, wherein the reservoir of biological control agents comprises an aqueous composition, and biological control agents being dispersed in the aqueous composition.

8. The system according to claim 7, wherein the aqueous composition comprises a gel prepared from one or more thickeners and/or gelling agents and an aqueous solution, the live biological control agents being homogeneously dispersed in the gel, said thickeners and/or gelling agents being non-toxic for said biological control agents and said gel having a dynamic viscosity at zero speed gradient comprised between 1 and 30 000 mPa·s.

9. The system according to claim 1, wherein the live biological control agents are mobile.

10. The system according to claim 1, wherein the live biological control agents are selected from the group consisting of mites and/or predatory insects.

11. The system according to claim 1, wherein the live biological control agents are mites from the phytoseiid family of genus Phytoseiulus.

12. The system according to claim 8, wherein the live biological control agents are insects of the Chrysoperla type which prey on insect pests.

13. A method for dispersing live biological control agents, comprising a step of spraying an aqueous composition of live biological control agents by a system according to claim 1, wherein a flow of main air is entrained from the source of compressed air to the spray tip, a flow of an aqueous composition comprising the live biological control agents in liquid phase is entrained to the opening, an average speed of the air flow in the air line being configured to spray the aqueous composition by shearing the aqueous composition by the air flow.

14. The method for dispersing live biological control agents according to claim 13, wherein the aqueous composition comprising the biological control agents is sprayed only by the flow of main air after exiting the opening.

15. The method for dispersing live biological control agents according to claim 13, wherein the system comprises compression means for compressing the reservoir of biological control agents, the compression means being configured to entrain a flow from the reservoir of biological control agents and/or from the enzyme reservoir to the liquid phase outlet, wherein the compression means are controlled so as to impose a pressure strictly less than 3 bar in the reservoir of biological control agents.
